(19) United States
(12) Patent Application Publication
(10) Pub. No.: US 2013/0257281 A1
(43) Pub. Date: Oct. 3, 2013

(54) Marker Lamp and Marker Lamp System

(71) Applicant: TOSHIBA LIGHTING & TECHNOLOGY CORPORATION, Yokosuka-shi (JP)

(72) Inventor: Shingo Niino, Yokosuka-shi (JP)

(73) Assignee: TOSHIBA LIGHTING & TECHNOLOGY CORPORATION, Yokosuka-shi (JP)

(21) Appl. No.: 13/832,574

(22) Filed: Mar. 15, 2013

(30) Foreign Application Priority Data
Mar. 29, 2012 (JP) 2012-077607

(51) Int. Cl. H05B 37/03

(52) U.S. Cl. CPC H05B 37/03; H05B 37/036
USPC 315/122; 315/119; 315/121

(57) ABSTRACT

According to one embodiment, a marker lamp is supplied with electric power from an alternating constant-current power supply device via a saturable device. The marker lamp includes a solid-state light-emitting circuit functioning as a light source and a lighting circuit configured to subject the solid-state light-emitting circuit to lighting control. The marker lamp further includes an abnormality monitoring device configured to monitor a state of the solid-state light-emitting circuit and open, if detecting an abnormal state, an output side of the saturable device corresponding to the marker lamp.

### INCORPORATION BY REFERENCE

The present invention claims priority under 35 U.S.C. §119 to Japanese Patent Application No. 2012-077607 filed on Mar. 29, 2012. The content of the application is incorporated herein by reference in their entirety.

### FIELD

Embodiments described herein relate generally to a marker lamp configured to detect an abnormal state of the marker lamp connected to an alternating constant-current power supply device and a marker lamp system employing the marker lamp.

### BACKGROUND

For example, in a marker lamp system in an airport, electric power is supplied from an alternating constant-current power supply device to a plurality of marker lamps via a saturable device, for example, a saturable isolation transformer. The saturable device is saturated at a predetermined voltage during an open circuit failure on a load side to enable power supply to other saturable devices and marker lamps.

As a marker lamp system in the past, there is proposed a marker lamp system configured to detect, if a light source of any one of a plurality of marker lamps provided in series to one another with respect to a saturable device is burned out, waveform distortion at every half cycle of an output waveform (a voltage or an electric current) of an alternating constant-current power supply device at a point when the saturable device is saturated and enable burn-out detection of a marker lamp on a control side.

A bulb such as a halogen bulb has been mainly used as a light source for a marker lamp. Therefore, only burn-out (open-circuit) has to be detected as an abnormality of the light source. Since the saturable device is saturated by the burn-out of the light source, it is possible to detect waveform distortion involved in the saturation and detect the burn-out.

On the other hand, in recent years, a maker lamp has been proposed in which a solid-state light-emitting circuit such as a light-emitting diode (hereinafter referred to as LED) is used from the viewpoint of power saving, long life, and the like. The solid-state light-emitting circuit such as the LED is lit by a direct current and can obtain a required light output with a small electric current compared with the bulb. Therefore, if the marker lamp employing the solid-state light-emitting circuit is lit by the alternating constant-current power supply device in the past, for stable lighting control for the solid-state light-emitting circuit, lighting circuits including current reducing sections, rectifying and smoothing sections, and current limiting sections are provided in marker lamps.

As an abnormal state of the solid-state light-emitting circuit, both of a short circuit and an open circuit could occur. However, since a consumed current of the solid-state light-emitting circuit is a small current in the first place and the lighting circuit is present, even if the solid-state light-emitting circuit is opened, the saturable device is not saturated. If the solid-state light-emitting circuit is short-circuited, since constant current control is performed, this abnormal state cannot be detected.

Therefore, it is difficult to detect an abnormality of the marker lamp.

### BRIEF DESCRIPTION OF THE DRAWINGS

FIG. 1 is a circuit diagram of a marker lamp and a marker lamp system according to an embodiment; and

FIG. 2 is a waveform chart for explaining a high-frequency on and off operation period ratio of a switching element included in a lighting circuit of the marker lamp.

### DETAILED DESCRIPTION

It is an object of the present invention to provide a marker lamp capable of detecting, even if a solid-state light-emitting circuit is used as a light source, an abnormality according to waveform distortion involved in saturation of a saturable device during an abnormality such as an open circuit or a short circuit and during an abnormality of a lighting circuit and a marker lamp system employing the marker lamp.

According to one embodiment, a marker lamp supplied with electric power from an alternating constant-current power supply device via a saturable device includes a solid-state light-emitting circuit functioning as a light source and a lighting circuit configured to subject the solid-state light-emitting circuit to lighting control. The marker lamp further includes an abnormality monitoring device configured to monitor a state of at least one of the solid-state light-emitting circuit and the lighting circuit and open, if detecting an abnormal state, an output side of the saturable device corresponding to the marker lamp.

According to this embodiment, if an abnormality of at least one of the solid-state light-emitting circuit and the lighting circuit is detected, the output side of the saturable device is forcibly opened. Therefore, the saturable device is suddenly saturated in a rising process of an output voltage at every half cycle of the alternating constant-current power supply device and distorts an output current or voltage waveform of the alternating constant-current power supply device compared with an output current or voltage waveform during regular time. Therefore, it is possible to detect the abnormality.

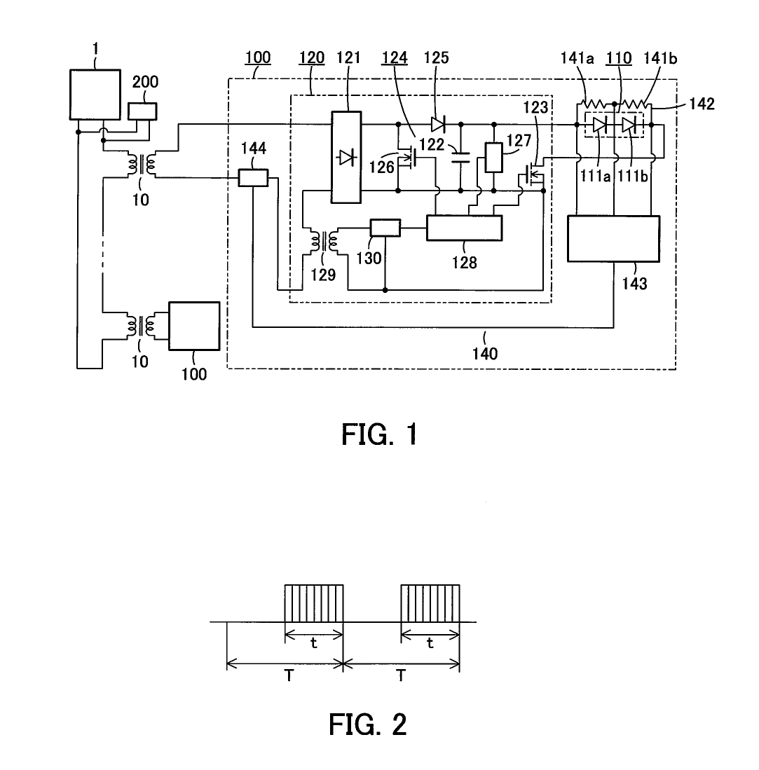

An embodiment of the present invention is explained below with reference to FIGS. 1 and 2.

FIG. 1 is a circuit diagram of a marker lamp and a marker lamp system according to the embodiment of the present invention.

Reference numeral 1 denotes an alternating constant-current power supply device. A maker lamp 100 is connected to the alternating constant-current power supply device 1 via, for example, a saturable isolation transformer functioning as a saturable device 10. A plurality of saturable devices 10 and a plurality of marker lamps 100 are connected to each other in series (in FIG. 1, only a part of the plurality of saturable devices 10 and the plurality of marker lamps 100 is shown in detail). The saturable device 10 is saturated during an open circuit failure on a secondary side to enable power supply to the other saturable devices 10 (the marker lamps 100).

In the case of a power supply device for marker lamps in an airport, for example, as in the case of a marker lamp employing a bulb, the alternating constant-current power supply device 1 is configured to be capable of changing an output current value in, for example, five stages of 6.6 A, 5.2 A, 4.1 A, 3.4 A, and 2.8 A. As such an alternating constant-current power supply device 1, for example, an alternating constant-current power supply device of a phase control type that outputs a phase control waveform using an SCR (Silicon Controlled Rectifier), an alternating constant-current power supply device of a resonant type that outputs a sine wave, and an alternating constant-current power supply device of an inverter control type that outputs a sine wave can be used. However, naturally, alternating constant-current power supply devices of other types may be used.

The saturable device 10 only has to be saturated or conducted during an open circuit failure on the secondary side or a load side to enable power supply to the other marker lamps 100. Therefore, another saturable element, an element that conducts in response to a voltage value, or the like can be used instead of the isolation transformer.

The marker lamp 100 includes a solid-state light-emitting circuit 110, a lighting circuit 120, and an abnormality monitoring device 140.

The solid-state light-emitting circuit 110 includes, for example, a light-emitting diode (hereinafter referred to as LED) as a solid-state light-emitting element. Two, four, or another required number of solid-state light-emitting circuits 110 are connected in series, connected in parallel, or connected in series and in parallel and used. In this embodiment, the solid-state light-emitting circuit 110 includes two LEDs 110a and 111b connected in series.

The lighting circuit 120 is configured to input an output of the alternating constant-current power supply device 1 to a rectifying device 121 first. A smoothing capacitor functioning as a smoothing section 122 is provided on an output side of the rectifying device 121.

The lighting circuit 120 is configured to be capable of changing output electric power. In this embodiment, the lighting circuit 120 includes, for example, a field-effect transistor functioning as a switching element 123 connected in series to the solid-state light-emitting circuit 110 between both output ends of the smoothing section 122.

Further, the lighting circuit 120 includes a constant voltage section 124 for converting an output of the smoothing section 122 into a constant voltage. The constant voltage section 124 mainly includes a switching device 126 provided on the output side of the rectifying device 121 to be electrically separated from the smoothing section 122 by a diode for backflow prevention 125 and a voltage detecting device 127 configured to detect both end voltages of the smoothing section 122.

Conduction of the switching device 126 is controlled by a control device 128 explained later according to a detection result of the voltage detecting device 127. The constant voltage section 124 converts an output voltage of the smoothing section 122 into a constant voltage.

When the constant voltage section 124 is used, the constant voltage section 124 is not limited to the constant voltage section in this embodiment and can be selected as appropriate from various constant voltage sections.

The alternating constant-current power supply device 1 outputs a relatively large electric current for a bulb such as an electric current of 6.6 A to 2.8 A. On the other hand, a required electric current of the solid-state light-emitting circuit 110 only has to be about several tens milliamperes to several hundreds milliamperes at most. Therefore, a difference between these electric currents needs to be reduced. However, this function may be performed by the constant voltage section 124. That is, an electric current equivalent to the difference only has to be bypassed via the switching device 126. However, this current reducing function may be performed by other means for, for example, providing switching taps on an output side of the isolation transformer functioning as the saturable device 10 and switching the switching taps according to an output current value 6.6 A to 2.8 A from the alternating constant-current power supply device 1.

The control device 128 controls an output of the switching element 123 according to an output current signal of the alternating constant-current power supply device 1. In this embodiment, the control device 128 subjects the switching element 123 to pulse width control (PWM).

A current signal in detecting the output current of the alternating constant-current power supply device 1 can be a route mean square value, an average value, a conduction phase, or the like according to a type, an output waveform, and the like of the alternating constant-current power supply device 1. In short, output level indicated by the output current of the alternating constant-current power supply device 1 is detected. A current detecting section 129 that detects the output current of the alternating constant-current power supply device 1 is a current detection transformer in FIG. 1. A detection signal of the current detecting section 129 is converted into an appropriate direct-current signal by a waveform shaping circuit 130 and input to the control device 128.

The control device 128 controls a high-frequency on and off operation period ratio (a high-frequency on and off operation period in one period of the PWM/ one period of the PWM) of the switching element 123 according to an output of the waveform shaping circuit 130. For example, as shown in FIG. 2, the control device 128 controls, at one period (T) of a PWM signal (e.g., between several hundreds hertz to several tens kilohertz), a time ratio of a high-frequency on and off operation period (t) in which a signal for turning on and off the switching element 123 at a high frequency (e.g., between several hundreds hertz to several tens megahertz) is output. Consequently, the control device 128 changes a supplied power amount to the solid-state light-emitting circuit 110 and changes a light output.

The control device 120 is suitably configured by mainly a microcomputer or an IC in terms of a reduction in size and weight. If the control device 128 is configured by mainly the microcomputer, it is easy to store or calculate conversion data in order to match a supplied current amount-to-light output characteristic in the solid-state light-emitting circuit 110 to a supplied current amount-to-light output characteristic in a bulb. However, naturally, the control device 128 is not limited to this.

Further, as the lighting circuit 128 in this embodiment, a feedback control section may be added. For example, an electric current flowing to the solid-state light-emitting circuit 110 may be detected and the high-frequency on and off operation period (t) of the switching element 123 or a frequency of high-frequency on and off or an on-duty may be changed to set the electric current to a predetermined electric current compared with a reference value corresponding to a dimming degree. Consequently, it is possible to control an electric current actually flowing to the solid-state light-emitting circuit 110 to an electric current corresponding to a dimming degree and accurately fix a light output.

The abnormality monitoring device 140 includes a state monitoring section 142, a determining section 143 configured to determine presence or absence of an abnormality, and an opening and closing section 144 capable of opening the output side of the saturable device 10.

In this embodiment, in the state monitoring section 142, resistors 141a and 141b are respectively connected to LEDs 111a and 111b in parallel. The state monitoring section 142 monitors both end voltages of parallel circuits respectively consisting of the LEDs 111a and 111b and the resistors 141a and 141b. That is, the resistors 141a and 141b having large resistance value are connected to forward direction drops of the LEDs 111a and 111b in parallel. Therefore, in the parallel circuit of the LED 111a and the resistor 141a and the parallel circuit of the LED 111b and the resistor 141b, if the LED 111a or 111b is open-circuited or short-circuited, the both end voltages of each of the parallel circuits substantially change compared with both end voltages at regular time.

Therefore, it is possible to detect an abnormality by comparing the change in the voltage value with a voltage value at regular time stored in advance or comparing the change in the voltage value with a voltage value of another circuit in the determining section 143.

The determining section 143 can be configured mainly by a microcomputer or an IC. In this case, the determining section 143 can be integrated with the control device 128. However, naturally, the determining section 143 may be configured by combining electronic components such as an operational amplifier and a semiconductor switch.

If the number of LEDs is three or more, the parallel resistors included in the state monitoring section 142 may be connected in parallel to correspond to the LEDs. The LED groups may be grouped into at least two groups and the resistors may be connected to correspond to each of the groups.

As the opening and closing section 144 that opens the output side of the saturable device 10, a switch section can be provided in series to an output winding wire of the isolation transformer. As the switch section, a semiconductor switching element, a relay, or the like can be used.

If the determining section 143 determines that an abnormal state occurs as explained above, the determining section 143 controls the opening and closing section 144 to open the output side of the saturable device 10.

Therefore, distortion occurs in an output waveform of the alternating constant-current power supply device 1. Burn-out detection of the marker lamp 100 is performed by detecting the waveform distortion with a burn-out detecting device 200 set in, for example, a control room. An analyzing section and an analyzing method for the waveform distortion in the burn-out detecting device 200 can be adopted as appropriate.

Electric power for the control device 128 of the lighting circuit 120, the determining section 143 and the opening and closing section 144 of the abnormality monitoring device 140, and the like may be obtained from an output of the rectifying device 121 or an output of the current detecting section 129 or may be obtained by separately providing a falling voltage transformer.

Action in this embodiment is explained.

If the alternating constant-current power supply device 1 is set to output an electric current for obtaining, for example, a desired light output of 100%, i.e., output an electric current of 6.6 A in this embodiment, a constant current of 6.6 A is supplied to each of the marker lamps 100 via the saturable device 10.

In each of the marker lamps 100, a direct-current voltage output from the rectifying device 121 is smoothed by the smoothing section 122, converted into a predetermined direct-current voltage, and fixed to a reduced predetermined voltage by the constant voltage section 124. The direct-current voltage is supplied to the solid-state light-emitting circuit 110 via the switching element 123.

On the other hand, an output current signal of the alternating constant-current power supply voltage 1 is input to the control device 128 from the current detecting section 129. Since the 100% electric current of 6.6 A is output now, the control section 128 subjects the on and off operation period of the switching element 123 to PWM control and supplies an electric current of, for example, 350 mA to the solid-state light-emitting circuit 110 in terms of a root mean square value. Consequently, the solid-state light-emitting circuit 110 is lit at brightness of 100%.

If the solid-state light-emitting circuit 110 is normal, the abnormality monitoring device 140 does not cause the opening and closing section 144 to operate. Therefore, the output side of the saturable device 10 is not opened. Distortion at abnormal time is not caused in an output waveform of the alternating constant-current power supply device 1.

On the other hand, if the solid-state light-emitting circuit 110 is abnormal, for example, one LED 111a is open-circuited, the both end voltage values of the parallel circuit including the LED 111a increase. If the one LED 111a is short-circuited, the both end voltages of the parallel circuit including the LED 111a decrease. Therefore, in both the abnormal states, the determining section 143 controls the opening and closing section 144 to open the output side of the saturable device 10.

Therefore, the saturable device 10 corresponding to the marker lamp 100 in which an abnormality occurs is unsaturated up to a certain degree of a voltage value in a half cycle of the alternating constant-current power supply device 1. However, if the voltage value rises to reach a saturated voltage, the saturable device 10 suddenly conducts. At this conduction time, transient waveform distortion occurs in an output waveform of the alternating constant-current power supply device 1. Therefore, the burn-out detecting device 200 can detect the abnormality of the marker lamp 100.

A dimming range can be arbitrarily set. However, in this embodiment, since the alternating constant-current power supply device 1 is configured to be capable of changing an output current value in five stages, it is possible to perform dimming in an arbitrary number of stage among the five stages. However, the dimming range is not limited to this. For example, so-called continuous dimming for continuously changing a light output may be performed.

The preferred embodiment of the present invention is mainly explained above. However, the present invention is not limited to the embodiment. Various modifications are allowed without departing from the spirit of the present invention.

For example, in the state monitoring section of the abnormality monitoring device, the resistors may be connected in parallel to the solid-state light-emitting circuit. The state monitoring section may detect a current signal flowing to this parallel circuit and detect presence or absence of an abnormality of at least one of the solid-state light-emitting circuit and the lighting circuit. However, in this case, a load current always flows to the detection resistors and the like and a power loss occurs.

Presence or absence of an abnormality may be detected on the basis of other physical amounts such as light and heat of the solid-state light-emitting circuit and heat of the lighting circuit besides the voltage and the current signal.

Various modifications of the lighting device are possible. For example, besides the current limiting section of the solid-state light-emitting circuit section that turns on and off current circulation to the solid-state light-emitting circuit, the current limiting section may be a current limiting section that controls, with the control device, an on-duty and a switching frequency of the switching device using a DC-DC conversion device including the switching device such as a falling voltage chopper to control power supply to the solid-state light-emitting circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A maker lamp supplied with electric power from an alternating constant-current power supply device via a saturable device, the marker lamp comprising:
a solid-state light-emitting circuit functioning as a light source;
a lighting circuit configured to subject the solid-state light-emitting circuit to lighting control; and
an abnormality monitoring device configured to monitor a state of at least one of the solid-state light-emitting circuit and the lighting circuit and open, if detecting an abnormal state, an output side of the saturable device corresponding to the marker lamp.

2. The marker lamp according to claim 1, wherein
the solid-state light-emitting circuit includes two or more solid-state light-emitting elements connected in series to one another, and
the abnormality monitoring device groups the two or more solid-state light-emitting elements into at least two groups, connects resistors respectively to the groups in parallel, and monitors both end voltages of each of the groups to thereby monitor a state of the solid-state light-emitting circuit.

3. The marker lamp according to claim 1, wherein the abnormality monitoring device includes a state monitoring section configured to monitor a state of the solid-state light-emitting circuit, a determining section configured to determine presence or absence of an abnormality, and an opening and closing section capable of opening an output side of the saturable device.

4. A marker lamp system comprising:
an alternating constant-current power supply device;
a plurality of saturable devices provided in series to one another on an output side of the alternating constant-current power supply device; and
a plurality of marker lamps supplied with electric power from the alternating constant-current power supply device via the saturable devices, each of the plurality of marker lamps including a solid-state light-emitting circuit functioning as a light source, a lighting circuit configured to subject the solid-state light-emitting circuit to lighting control, and an abnormality monitoring device configured to monitor a state of at least one of the solid-state light-emitting circuit and the lighting circuit and open, if detecting an abnormal state, an output side of the saturable device corresponding to marker lamp.

5. The system according to claim 4, wherein
the solid-state light-emitting circuit includes two or more solid-state light-emitting elements connected in series to one another, and
the abnormality monitoring device groups the two or more solid-state light-emitting elements into at least two groups, connects resistors respectively to the groups in parallel, and monitors both end voltages of each of the groups to thereby monitor a state of the solid-state light-emitting circuit.

6. The system according to claim 4, wherein the abnormality monitoring device includes a state monitoring section configured to monitor a state of the solid-state light-emitting circuit, a determining section configured to determine presence or absence of an abnormality, and an opening and closing section capable of opening an output side of the saturable device.
